(19) United States
(12) Patent Application Publication
(10) Pub. No.: US 2016/0318666 A1
(43) Pub. Date: Nov. 3, 2016

(54) Reclose Concept of Roll & Close for Pillow & Side Gusset Bags

(71) Applicant: PRINTPACK ILLINOIS, INC., Elgin, IL (US)

(72) Inventors: Rajesh Suryanarayanan, Powder Springs, GA (US); Jeffrey Allen Boekeloo, Acworth, GA (US)

(21) Appl. No.: 15/103,737

(22) PCT Filed: Dec. 9, 2014
(86) PCT No.: PCT/US14/69298

§ 371 Date: Jun. 10, 2016

Related U.S. Application Data
(60) Provisional application No. 61/917,613, filed on Dec. 18, 2013.
(60) Provisional application No. 61/915,454, filed on Dec. 12, 2013.

(51) Int. Cl. B65D 33/16; B31B 29/74; B65D 33/00

(52) U.S. Cl. CPC B65D 33/1658; B65D 33/004; B31B 29/74; B31B 2221/20; B31B 2219/9012

(57) ABSTRACT

Recloseable packages for containing a product therein are provided that include a flexible container having a front side and a back side sealed together along at least one longitudinal seam and two lateral end seams, and a flexible film member having opposed ends permanently adhered to the flexible container. At least a portion of the flexible film member being configured to releasably secure between the permanently adhered opposed ends of the flexible film member one of the two lateral end seams of the flexible container subsequent to opening one of the two lateral end seams. Also disclosed are methods of fabricating and using the recloseable packages provided, as well as a flexible film for forming such packages.

### CROSS-REFERENCE TO RELATED APPLICATIONS

This application claims priority to U.S. Provisional Application No. 61/915,454, filed Dec. 12, 2013, and U.S. Provisional Application No. 61/917,613, filed Dec. 18, 2013, each of which is incorporated by reference herein in its entirety.

### BACKGROUND

The present application relates generally to packages for containing various products. More particularly, the present application relates to a package that can be repeatedly opened and closed.

Given the desire of consumers to have the ability to easily and repeatedly open and close a package, a variety of different types of recloseable packages have been investigated. However, such known recloseable packages present various problems that make them undesirable for manufacture, consumer use, or both. For example, one widely known type of recloseable package employs a press-to-close zipper, or other closure system compatible with flexible packages of plastic film construction so as to afford the consumer the ability to repeatedly open and close the package. Recloseable flexible packaging is often made by printing and laminating film, attaching a press-to-close zipper or other closure system to the film, rolling the film with the closure onto a reel, shipping the reel to a product packaging site, loading the reel into a form-fill-seal machine to manufacture, i.e. form, fill, and seal, the finished package containing product. Unfortunately, such press-to-close zippers or other closure systems generally result in high manufacturing costs, as well as impose difficulty in handling the film roll due to the bulky nature that ensues after application of the zippers. Also, such press-to-close zippers or other closure systems may increase the bulk of film rolls and result in loss of printed impressions per roll of film which increases the cost of manufacture due to increased changeovers, down time of machines, and fewer impressions per pallet, per truck. Furthermore, some consumers, e.g. the elderly and children, may find it difficult to properly operate and manipulate press-to-close zippers or other closure systems during repeated opening and closing of the package.

Thus, there exists a need to provide a cost-effective and useful solution for reclosing and resealing a package in a manner which will allow for simple manufacture, as well as provide the consumer the ability to easily and repeatedly open and close the recloseable package to access the products contained therein.

### SUMMARY

The present teachings provide for a recloseable package for containing a product therein that is readily accommodated by modern packaging and filling techniques, e.g. a form-fill-seal process, is easy to use, and is designed for compatibility with various bag constructions. The recloseable package includes a flexible container having a front side and a back side sealed together along one or more longitudinal seams and two lateral end seams. The recloseable package also includes a flexible film member having opposed ends permanently adhered to the flexible container. The flexible film member is configured to releasably secure between the opposed ends one of the two lateral end seams of the flexible container subsequent to opening one of the two lateral end seams.

The present teachings also provide for a method of fabricating a recloseable package for containing a product therein. The method includes adhering opposed ends of a flexible film member permanently onto a flexible container body film and forming the flexible container body film into a flexible container having a front side and a back side sealed together along one or more longitudinal seams and two lateral end seams. Thus, the method results in the flexible film member being structured and arranged on the flexible container so as to releasably secure one of the two lateral end seams of the flexible container subsequent to opening one of the two lateral end seams.

The present teachings further provide for a method for releasably securing a recloseable package. The recloseable package includes a flexible container having a front side and a back side sealed together along one or more longitudinal seams and two lateral end seams. The recloseable package further includes a flexible film member having opposed ends permanently adhered to the flexible container to releasably secure between the opposed ends one of the two lateral end seams of the flexible container. The method includes opening the one lateral end seam and securing the one lateral end seam of the flexible container between the adjacent front side or back side of the flexible container and the flexible film member.

The present teachings also provide for a flexible film for forming a recloseable package, in which the flexible film includes a flexible container body film and a flexible film member having opposed ends permanently adhered to the flexible container body film.

### BRIEF DESCRIPTION OF THE DRAWINGS

The present teachings are illustratively shown and described in reference to the accompanying drawings, in which

FIG. 1A is a front view of a recloseable package according to one embodiment;

FIG. 1B is a back view of the embodiment depicted in FIG. 1A;

FIG. 2A-2C are schematic illustrations of the recloseable package shown in FIGS. 1A and 1B being releasably secured;

FIG. 3A is a back view of one embodiment of the flexible film member depicted in the recloseable package shown in FIGS. 1A and 1B;

FIG. 3B is a back view of another embodiment of the flexible film member depicted in the recloseable package shown in FIGS. 1A and 1B;

FIG. 3C is a is a back view of a further embodiment of the flexible film member depicted in the recloseable package shown in FIGS. 1A and 1B;

FIG. 3D is a back view of another embodiment of the flexible film member depicted in the recloseable package shown in FIGS. 1A and 1B;

FIG. 4A is a front view of a recloseable package according to another embodiment;

FIG. 4B is a back view of the embodiment depicted in FIG. 4A;

FIGS. 5A-5C are schematic illustrations of the recloseable package shown in FIGS. 4A and 4B being releasably secured;

FIG. 6A is a back view of one embodiment of the flexible film member depicted in the recloseable package shown in FIGS. 4A and 4B;

FIG. 6B is a back view of another embodiment of the flexible film member depicted in the recloseable package shown in FIGS. 4A and 4B;

FIG. 6C is a back view of a further embodiment of the flexible film member depicted in the recloseable package shown in FIGS. 4A and 4B;

FIGS. 7A-7C are schematic illustrations of a recloseable package according to another embodiment being releasably secured; and

FIGS. 8A-8C are schematic illustrations of a recloseable package according to another embodiment being releasably secured.

### DETAILED DESCRIPTION

The present teachings are directed to recloseable packages for containing a product therein that utilizes a flexible film member to allow for repeated opening and closing of the package. Also provided herein are methods for manufacturing recloseable packages and methods for releasably securing recloseable packages. Parameters of different steps, components, and features of the embodiments are described separately, but may be combined consistently with this description and claims to enable other embodiments as will be understood by those skilled in the art.

The recloseable packages of the present teachings include a flexible container having a front side and a back side that are sealed together along one or more longitudinal seams and two lateral end seams to define a cavity for containing a product within the recloseable package. In certain embodiments, the recloseable packages may take the form of pillow packages, whereas in other embodiments the recloseable packages may take the form of stand up pouches or side gusset packages, each of which may be manufactured, for example, by way of a horizontal or vertical form-fill-seal process. In further embodiments, the recloseable packages can be used as flexible liner-type packages, such as those for packaging bulk food items, such as cereal, used in a bag-in-a-box container system. Those skilled in the art will appreciate that such recloseable packages may be formed from a single web of film using a longitudinal fin seal or lap seal, or alternatively, may be formed using two or more webs sealed together along the longitudinal edges of the webs.

The flexible container may be formed from a single or multi-layer film using one or more flexible film materials suitable for use in packaging the product concerned. For example, in certain embodiments, the flexible film materials may include one or more layers of one or more paper-based materials, polymeric materials, metallized polymeric materials, metallic foils, or combinations thereof. Non-limiting examples include single layer or multi-layer films of suitable polymers, including but not limited to polyolefins, such as polyethylene terephthalate (PET), polypropylene (PP), polyamide (PA), and coated paper, it being understood that many other polymers, copolymers, and combinations thereof are also suitable. These materials may be produced as a cast or blown film and may be subsequently biaxially or monoxially oriented. Further functionality may be added by coating the materials by a vacuum deposition, aqueous deposition, spray process or other means. Depending on the desired characteristics of the recloseable package, the flexible film material may be selected to impart the desired properties to the container, i.e., transparency, or in some instances may further comprise printing, such as color, designs, graphics and other indicia, thereon. The front side and back side of the flexible container may be formed from the flexible film material, for example, by a horizontal or vertical form-fill-seal manufacturing process using heat sealing, cold sealing, ultrasonic sealing, radio frequency welding, induction welding or combinations thereof to form the one or more longitudinal seams and two lateral end seams.

The recloseable packages of the present teachings, in addition to the flexible container, further include a flexible film member having opposed ends that are permanently adhered to the flexible container. The flexible film member may be disposed on the front side, back side, or both sides of the flexible container. For example in one embodiment, the flexible film member may be disposed laterally across the front side of the flexible container with the opposed ends being permanently adhered to the front side, such that the area between the opposed ends of the flexible film member sits laterally across a portion of the front side of the flexible container. In another embodiment, the flexible member may extend from the front side to the back side of the flexible container with the opposed ends of the flexible film member being permanently adhered to the back side, such that the area between the opposed ends of the flexible film member sits laterally across the entire front side of the flexible container and may extend onto a portion of the back side of the flexible container. It should be noted that it can be advantageous for the flexible film member to be sufficiently taut against the adjacent front or back side of the flexible container to releasably secure one of the two lateral end seams of the flexible container between the opposed ends of the flexible film member and between the flexible film member and the flexible container subsequent to the opening of the one of the two lateral end seams.

The flexible film member is configured to releasably secure one of the two lateral end seams of the flexible container between the permanently adhered opposed ends subsequent to the opening of the one of the two lateral end seams. In other words, after unsealing at least a portion of one of the two lateral end seams by separating at least a portion of the front side from the back side of the flexible container, the opened lateral end seam can be folded and tucked between the flexible film member and the flexible container to contain the unused contents of the package therein.

As used herein, the term “permanently adhered” refers to a bond strength sufficient to adhere the flexible film member to the flexible container so as to not allow detachment of the flexible film member from the flexible container when securing one of the two lateral end seams of the flexible container between the flexible film member and the adjacent side of the flexible container subsequent to the opening of the one of the two lateral end seams. In certain embodiments the bond strength of the permanently adhered opposed ends is sufficient so as to not allow detachment of the flexible film member from the flexible container without tearing, rupturing, or deforming, the film of the flexible container or the flexible film member. For instance, in some embodiments the bond strength may be from about 3.53 ounces force/inch width to about 35.28 ounces/inch grams force/inch width as measured in accordance with ASTM# D6252/D6252M—98, preferably about 5.29 ounces force/inch width to about 7.06 ounces force/inch width, for materials adhered with one or more adhesives, e.g. pressure-sensitive adhesives, hot melts, etc., or any other type of bonding method such as heat sealing or ultrasonic welding or the like.

In certain embodiments, the length of the flexible film member may be sufficiently long so as to provide a large enough surface to releasably secure at least one of the two lateral end seams of the flexible container between the permanently adhered opposed ends subsequent to the opening of the at least one of the two lateral end seams. In some embodiments, the length of the flexible film member is about 0.50 inches (1.37 centimeters) or greater at the longest point. As used herein, the length (L) of the flexible film member refers to the longitudinal distance between the top and bottom lateral edges of the flexible film member (i.e., the length is perpendicular to the width of the flexible film member between the permanently adhered opposed ends of the flexible film member). In one embodiment, the length of the flexible film member is about 0.50 (1.37 centimeters) inches to about 2.0 inches (5.08 centimeters) at the longest point. In another embodiment, the length of the flexible film member is about 0.50 inches (1.37 centimeters) to about 1.0 inch (2.54 centimeters) at the longest point. In yet another embodiment the length of the flexible film member is about 0.50 inches (1.37 centimeters) to about 0.75 inches (1.90 centimeters) at the longest point.

The width of the flexible film member should be sufficient to receive and releasably secure one of the two lateral end seams of the flexible container that is folded (or rolled) and tucked between the opposed ends of the flexible film member and the adjacent side of the flexible container subsequent to opening one of the two lateral end seams. The thickness of the flexible film member in accordance with the present teachings may be sufficient so as to afford stability to the flexible film member in order to impart the desired functionality. For example, in some embodiments the thickness of the film may be at least 0.35 mils (8.89 microns) to about 3.0 mils (76.2 microns).

The flexible film member may be formed as a laminate or non-laminate, a coextruded film, a cast film, an adhesive label, or the like, using any flexible material(s) suitable for use in packaging the product concerned. For example, in embodiments, the flexible film member may include one or more layers of one or more paper-based materials, polymeric materials, metallized polymeric materials, metallic foils, and combinations thereof. Non-limiting examples include single layer or multi-layer films of suitable polymers, including but not limited to polyolefins, such as polyethylene terephthalate (PET), polypropylene (PP), polyamide (PA), and coated paper, it being understood that many other polymers, copolymers, and combinations thereof are also suitable. These materials may be produced as a cast or blown film and may be subsequently biaxially or monoxially oriented. Further functionality may be added by coating the materials by a vacuum deposition, aqueous deposition, spray process or other means. Depending on the desired characteristics of the recloseable package, the flexible film member material may be selected to impart the desired properties to the container, i.e., transparency, or in some instances may further comprise printing, such as color, designs, graphics and other indicia, thereon. Furthermore, the flexible film member may be attached to the flexible container by the use of one or more adhesives, e.g. pressure sensitive adhesives, or any other type of bonding method using heat sealing, cold sealing, ultrasonic sealing, radio frequency welding, induction welding or combinations thereof.

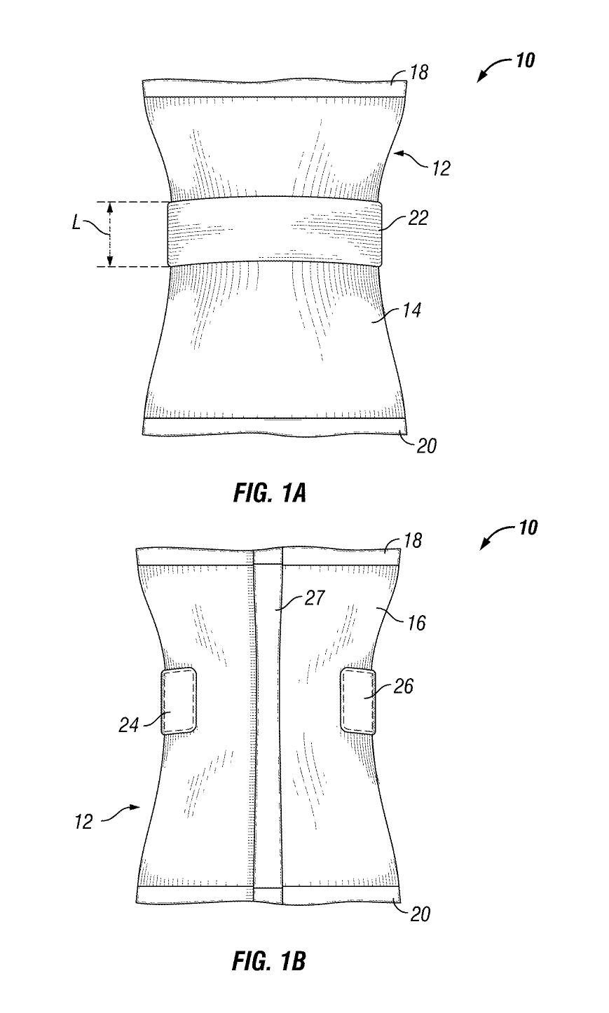

An exemplary embodiment of a recloseable package is illustrated in FIGS. 1A and 1B. The recloseable package 10 includes a flexible container 12 having a front side 14 and a back side 16 sealed together along one or more longitudinal seams 27 and two lateral end seams 18 and 20. The recloseable package 10 further includes a flexible film member 22 having opposed ends 24 and 26 that are permanently adhered to the flexible container 12. The flexible film member 22 is configured to releasably secure between the opposed ends 24 and 26 one of the two lateral end seams 18, 20 of the flexible container 12, subsequent to the opening of the one of the two lateral end seams 18, 20.

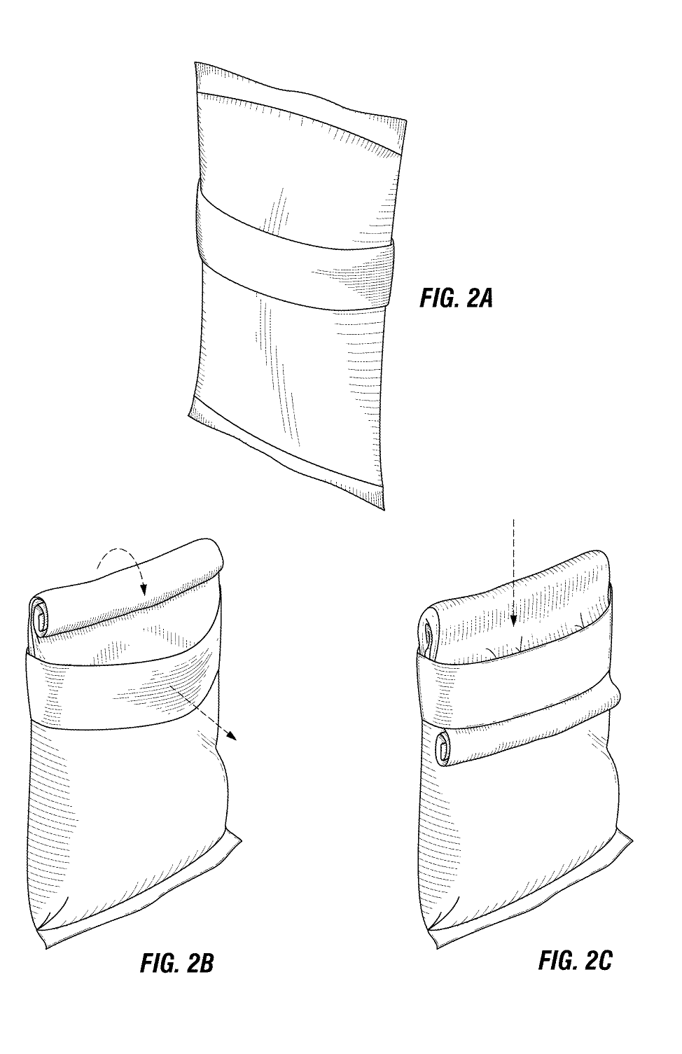

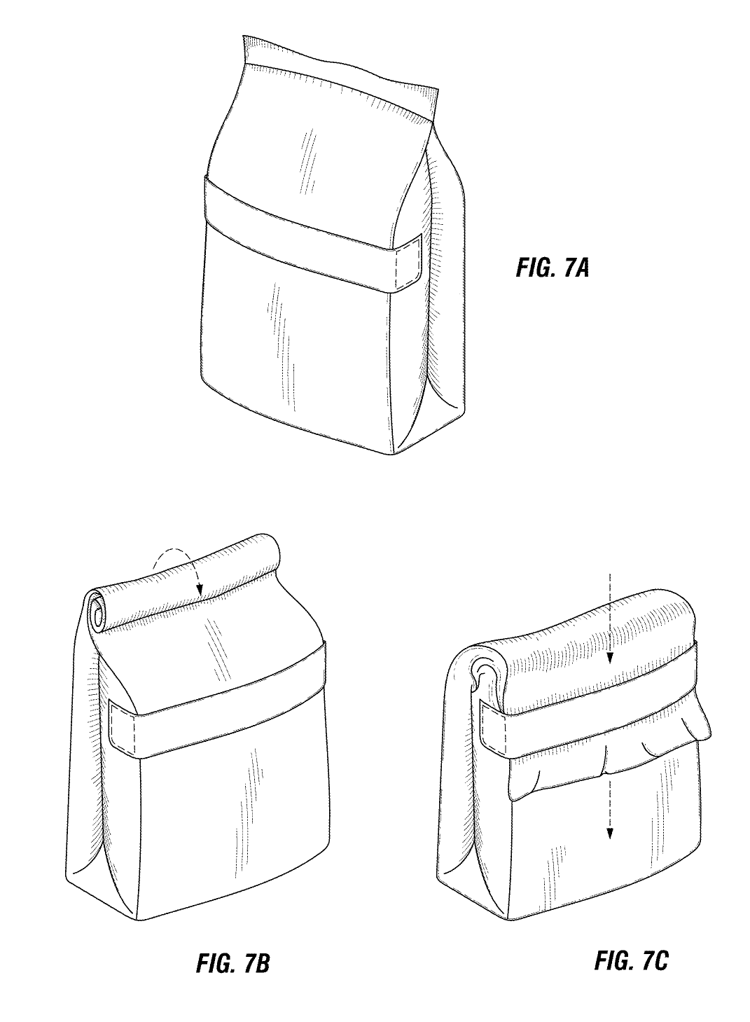

A method for releasably securing the recloseable package of such embodiment illustrated in FIGS. 1A and 1B may be better understood by reference to the schematic illustrations in FIGS. 2A-2C that depict the embodiment being opened and closed, including opening of one of the two lateral end seams and securing the one of the two lateral end seams of the flexible container between the flexible container and the flexible film member. In instances where an embodiment of the recloseable package includes side gusset panels, a method for releasably securing such recloseable package may be better understood by reference to the schematic illustrations in FIGS. 7A-7C that depict the embodiment being opening and closed.

The positioning of the flexible film member onto the flexible container may be varied. For example, in some embodiments the flexible film member may be disposed onto either the upper half of the flexible container, the upper third of the flexible container, or the upper quarter of the flexible container (i.e., the upper half, upper third, and upper quarter being longitudinally disposed relative to the two lateral end seams) such that one or either of the lateral end seams may be releasably secured between the opposed ends of the flexible film member subsequent to opening one or either of the lateral end seams. In other embodiments the flexible film member may be disposed between the upper half and the upper third of the flexible container. In alternative instances, the flexible film member may be disposed at, above or below the fill line for the product.

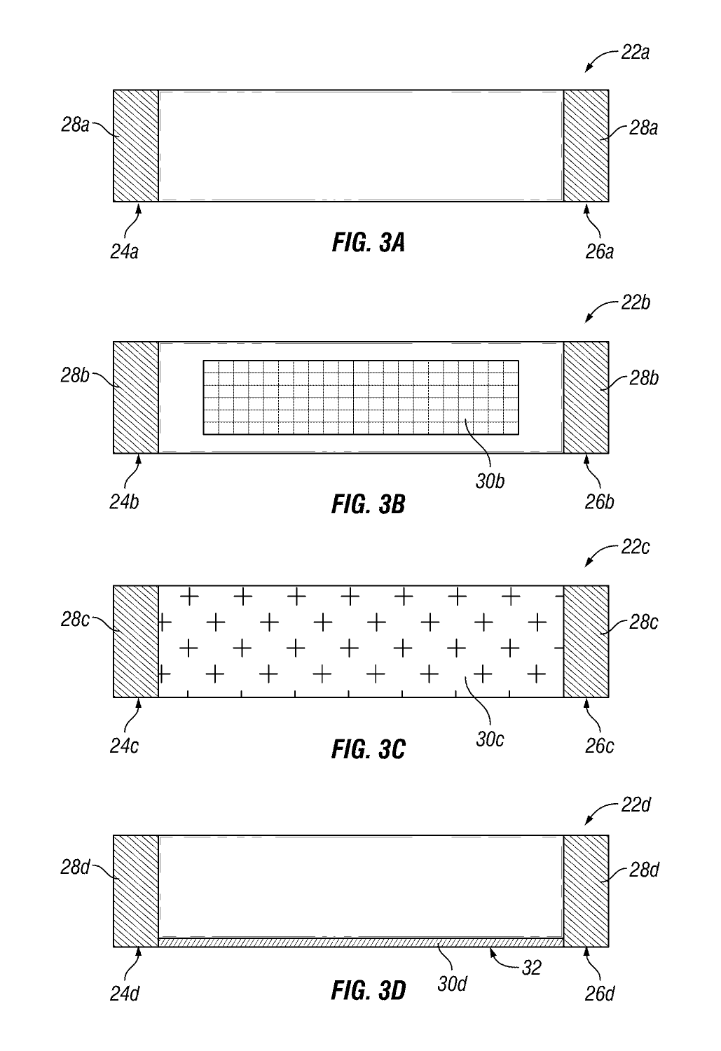

In certain embodiments of the present teachings, the recloseable package may further comprise one or more adhesives disposed onto one or more portions of the flexible film member. In certain embodiments, as shown in FIG. 3A, the one or more adhesives 28a may be disposed onto the opposed ends 24a and 26a of the flexible film member 22a. In other embodiments, as shown in FIG. 3B, one of the one or more adhesives 28b may be disposed onto the opposed ends 24b and 26b of the flexible film member 22b and another one of the one or more adhesives 30b may be disposed onto the portion of the flexible film member 22b that is between the opposed ends 24b and 26b. Alternatively in other embodiments, as shown in FIG. 3C, the one or more adhesives 28c may be disposed onto the opposed ends 24c and 26c of the flexible film member 22c and an adhesive pattern or kill zone 30c may be disposed onto a portion of the flexible film member 22c that is between the opposed ends 24c and 26c. In further alternative embodiments, as shown in FIG. 3D, the one or more adhesives 28d may be disposed onto the opposed ends 24d and 26d and of the flexible film member 22d, and an adhesive 30d may be disposed onto the bottom portion 32 of the flexible film member 22d, for example, as an adhesive pattern or kill zone, to temporarily adhere the bottom portion 32 of the flexible film member 22d to the flexible container body film during manufacturing, e.g. form-fill-seal process, filling, transporting, stocking, and displaying the recloseable package.

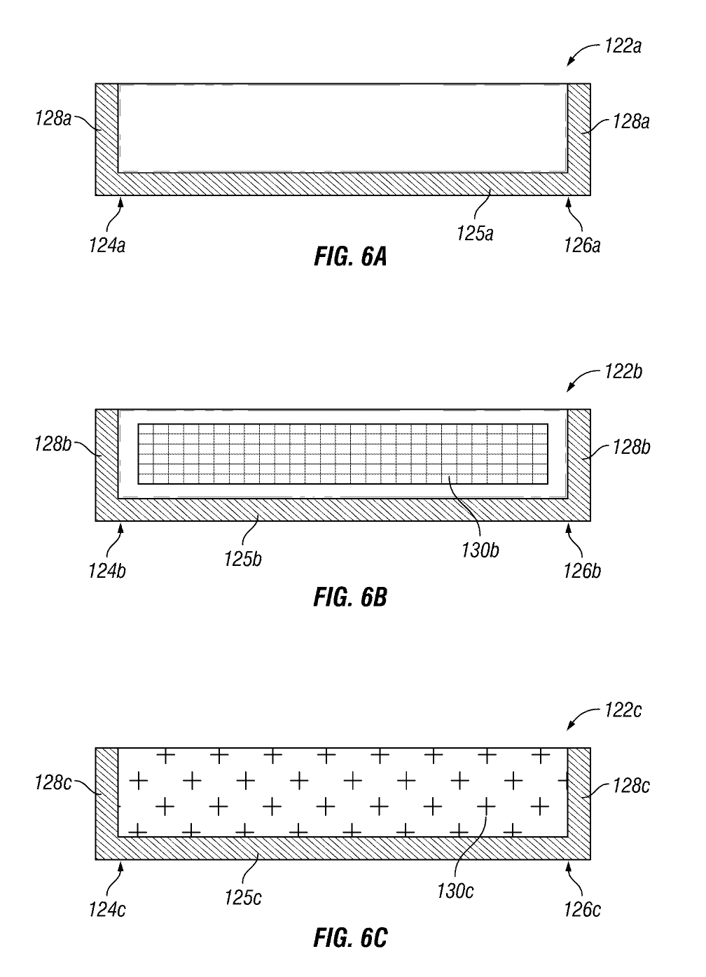

A reduction in bond strength may be accomplished in a variety of means, including but not limited to the selective application of one or more adhesives over a portion or all of the area in which a reduced bond strength is desired, (e.g., using an adhesive pattern), or through the use of a kill zone. As used herein, the term “kill zone” refers to an area in which the bond strength of the adhesive is reduced as compared to an area with adhesive without the kill zone. For example, a kill zone may be formed by applying one or more adhesives and then applying one or more deadening agents over the one or more adhesives for which the reduction of bond strength is desired. In certain embodiments, the kill zone may be a pattern or shape, e.g. FIGS. 3C and 6C, and may further take the form of a logo or graphic.

The one or more adhesives may be any known agent or material which provides the desired affinity between the flexible film member and the flexible container at the preferred locations. It should be noted that the desired affinity between the flexible film member and the flexible container at the preferred locations may be the same or may vary from one another. Non-limiting examples of suitable adhesive materials include acrylics, rubbers, hot glues, or combinations thereof.

In a further embodiment of the present teachings, at least a portion of the flexible film member between the opposed ends may be temporarily adhered to at least one of the front or back side of the flexible member with the use of one or more adhesives, with or without a kill zone, disposed onto at least one of the flexible film member or flexible container, e.g. FIGS. 3B-D and 6B-C, in the area for which temporary adhering is desired. Alternatively, the flexible film member may have a coefficient of friction or tackiness sufficient to effectively temporarily adhere the flexible film member to the front or back side of the flexible container. One of the advantages to these embodiments is that once the temporarily adhered portion is detached from the flexible container, such portion may aid in releasably securing one of the two lateral end seams between the opposed ends of the flexible film member subsequent to the opening of the one of the two lateral end seams Another advantage to this embodiment is that temporarily adhering at least a portion of the flexible film member between the opposed ends may also help prevent the pre-detachment of the flexible film member from that of the flexible container during manufacturing, e.g. form-fill-seal process, filling, transporting, stocking, and displaying the recloseable package.

As used herein, the term “temporarily adhered” refers to having a bond strength sufficient to hold the flexible film member in place against the flexible container during manufacturing and normal handling of the flexible container, but low enough to allow detachment of the temporarily adhered portion of the flexible film member from the flexible container without tearing, rupturing, or deforming the film of the flexible container or the flexible film member or breaking or compromising the permanent bonds between the opposed ends of the flexible film member and the flexible container. For instance, in some embodiments the bond strength of the adhesives used, with or without a kill zone, to temporarily adhere the flexible film member to the flexible container may be from about 0.71 ounces force/inch width to about 7.06 ounces force/inch width as measured in accordance with ASTM# D6252/D6252M—98, preferably about 0.71 ounces force/inch width to about 3.18 ounces force/inch width.

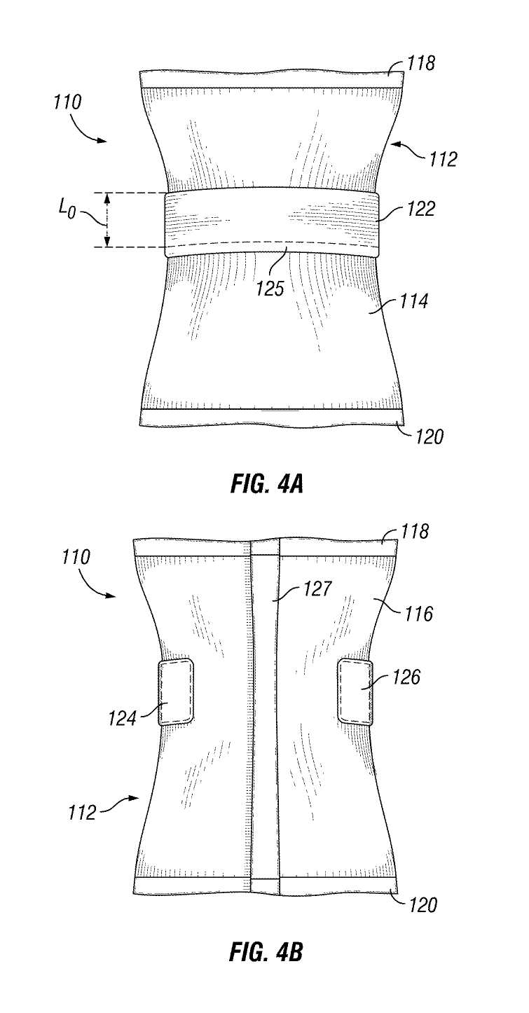

In another embodiment of the present teachings, at least a portion of the flexible film member between the opposed ends may be permanently adhered to at least one of the front side or back side of the flexible container. For example, as illustrated in FIGS. 4A and 4B, both the opposed sides 124 and 126 and the bottom portion 125 of the flexible film member 122 may be permanently adhered to the flexible container 112. Thus, such an embodiment affords the flexible film member 122 to form a pocket-like structure, e.g. the top portion of the flexible film member being substantially open, that further aids in the releasable securement of one of the two lateral end seams 118, 120 subsequent to the opening of the one of the two lateral end seams 118, 120. More specifically, once at least a portion of the front side 114 and back side 116 of the flexible container 110 are separated at one of the two lateral end seams, a portion of the flexible container 110, including the one of the two lateral end seams 118, 120 can then be folded and tucked into the pocket-like structure, resulting in releasable securement between the opposed ends 124 and 126 and within the pocket-like structure itself. In these embodiments the length (Lₒ) of the flexible film member 122 may be sufficiently long, so as to provide a large enough surface to releasably secure between the opposed ends 124, 126 and within the pocket-like structure at least one of the two lateral end seams 118, 120 of the flexible container 110 subsequent to the opening of the one of the two lateral end seams 118, 120.

In some embodiments, the length (Lₒ) of the flexible film member that extends from the top lateral portion to the permanently adhered bottom lateral portion of the flexible film member (e.g. the non-adhered or temporarily adhered portion of the flexible film member) is about 0.70 inches (1.78 centimeters) or greater at the longest point. In one embodiment, the length (Lₒ) of the flexible film member that extends from the top lateral portion to the permanently adhered bottom lateral portion of the flexible film member (e.g. the non-adhered or temporarily adhered portion of the flexible film member) is about 0.70 inches (1.78 centimeters) to about 2.0 inches (5.08 centimeters) at the longest point. In another embodiment the length (Lₒ) of the flexible film member that extends from the top lateral portion to the permanently adhered bottom lateral portion of the flexible film member (e.g. the non-adhered or temporarily adhered portion of the flexible film member) is about 0.70 inches (1.78 centimeters) to about 1.0 inch (2.54 centimeters) at the longest point. In yet another embodiment the length (Lₒ) of the flexible film member that extends from the top lateral portion to the permanently adhered bottom lateral portion of the flexible film member (e.g. the non-adhered or temporarily adhered portion of the flexible film member) is about 0.70 inches (1.78 centimeters) to about 0.90 inches (2.28 centimeters) at the longest point.

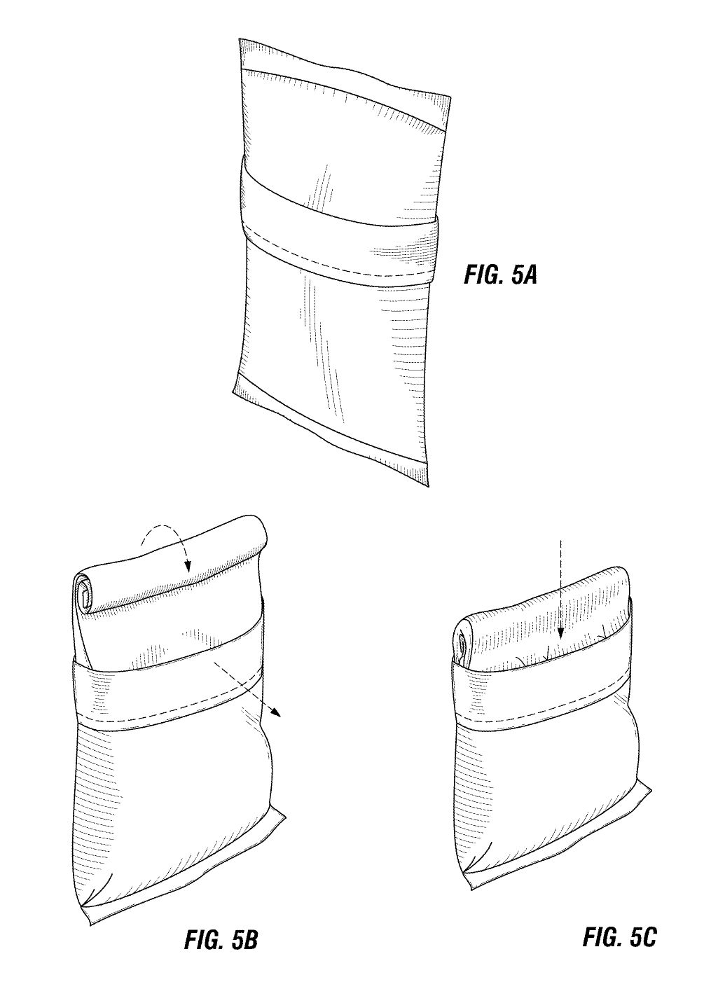

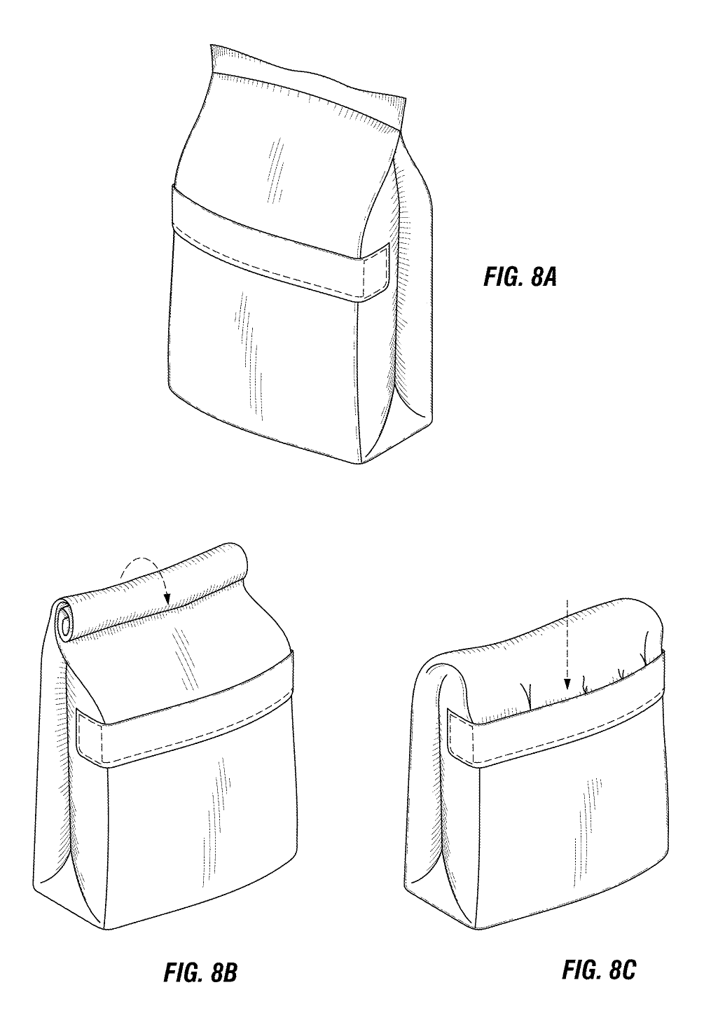

A method for releasably securing the recloseable package of such embodiment illustrated in FIGS. 4A and 4B may be better understood by reference to the schematic illustrations in FIGS. 5A-5C that depict the embodiment being opened and closed, including opening the flexible container and securing the one of the two lateral end seams of the flexible container between the flexible container and the flexible film member. In instances where an embodiment of the recloseable package includes side gusset panels, a method for releasably securing such recloseable package may be better understood by reference to the schematic illustrations in FIGS. 8A-8C that depict the embodiment being opening and closed.

In certain embodiments of the present teachings, the recloseable package may further comprise one or more adhesives disposed onto the opposed ends and the bottom portion of the flexible film member. In certain embodiments, as shown in FIG. 6A, the one or more adhesives 128a may be disposed onto the opposed ends 124a and 126a and the bottom portion 125a of the flexible film member 122a. In other embodiments, as shown in FIG. 6B, one of the one or more adhesives 128b may be disposed onto the opposed ends 124b and 126b and the bottom portion 125b of the flexible film member 122b and another one of the one or more adhesives 130b may be disposed onto the portion of the flexible film member 122b that is between the opposed ends 124b and 126b. Alternatively in other embodiments, as shown in FIG. 6C, the one or more adhesives 128c may be disposed onto the opposed ends 124c and 126c and the bottom portion 125c of the flexible film member 122c and an adhesive pattern or kill zone 130c disposed onto a portion of the flexible film member 122c that is between the opposed end 124c and 126c.

The method for fabricating recloseable packages provided herein may include adhering a flexible film member onto a flexible container body film and forming the flexible container body film into a flexible container having a front side and a back side sealed together along at least one longitudinal seam and two lateral end seams. Thus, the flexible film member is structured and arranged on the flexible container so as to releasably secure one of the two lateral end seams of the flexible container subsequent to the opening of the one of the two lateral end seams.

In embodiments, the flexible film member is adhered to the flexible container body film. The method for adhering the flexible film member permanently onto the flexible container body film may include applying the flexible film member to the flexible container, in off-line or in-line processes with respect to packaging of the product, and also may be formed in both horizontal and vertical form-fill-seal operations, among others.

For example, the flexible film member may be applied to the flexible container body film and formed into a flexible container in-line just before the package is formed, filled with product and sealed. Alternatively, the flexible film member may be applied to the flexible container body film, wound on a reel, and then loaded into vertical or horizontal form-fill-seal equipment on which it is then unwound and formed into a flexible container, filled with product and sealed.

The method for adhering the flexible film member onto the flexible container body film may include applying the flexible film member to the flexible container body film using any suitable methods known to those skilled in the art. Non-limiting examples include, applying a flexible film member in the form of a die cut label (e.g., using a label applicator); using a patch applicator having a patch cutter and a vacuum application cylinder to die cut a label stock to a desired length and width to produce the flexible film member and then applying the flexible film member on the flexible container body film; applying one or more adhesives to a flexible film member and placing the flexible film member on the flexible container body film; co-extruding a film that is cut to form the flexible film member and applying the flexible film member to the flexible container body film using pressure sensitive adhesive, heat sealing, cold sealing, ultrasonic sealing, radio frequency welding, induction welding or combinations thereof.

For example, the flexible film member may be applied to the flexible container body film with the use of one or more adhesives. The one or more adhesives can be applied by anilox rollers, engraved cylinder or other means to the flexible film member in the desired pattern, the amount and type of adhesive agent can be varied to obtain the desired result, and then the flexible film member can be attached to the flexible container body film. Alternatively, the one or more adhesives can be applied to flexible container body film in the same manner as described above, and the flexible film member can then be applied over the one or more adhesives to attach the flexible film member to the flexible container body film. Thus, in either instance, once the flexible container body film that forms the flexible container reaches the bag formation step, the flexible film member is already adhered to the flexible container body film.

In certain embodiments, the method of manufacture includes providing a flexible container body film for forming a flexible container using a flexible thin film of the type commonly employed in the art to produce flexible bags using a typical vertical or horizontal form-fill-seal packaging machine, and are typically constructed of thin film layers of up to about 400 gauge thickness. The flexible container body film may be mono- layered or multi-layered, and may be printed, clear, laminated, metalized, etc. In certain embodiments, the desired product environment to be maintained within the package drives the types and arrangements of thin films that are chosen for a particular packaging application. Other considerations can include desired shelf life, and cost. A plurality of package designs are possible, depending on the preceding factors. The materials making up the film layers, primarily plastics, are well known in the art. These materials may vary in cost, as well as in their physical characteristics, such as flexibility, strength, gauge and permeability to substances that decrease the shelf life of a food product, such as oxygen, moisture, and light.

Additional methods for forming flexible packages and applying adhesive labels and other recloseable members are known in the art, and may be adapted for purposes of forming the recloseable flexible packages provided herein. See e.g., U.S. Patent Publication No. 2013/0121623, U.S. Patent Publication No. 2012/0183241, and U.S. Patent Publication No. 2011/0038571, the relevant portions of which are incorporated herein by reference.

For the purposes of describing and defining the present teachings, it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Although the teachings have been described with respect to various embodiments, it should be realized these teachings are also capable of a wide variety of further and other embodiments within the spirit and scope of the appended disclosure.

We claim:

1. A recloseable package for containing a product therein, said recloseable package comprising:
a flexible container having a front side and a back side sealed together along at least one longitudinal seam and two lateral end seams; and
a flexible film member having opposed ends permanently adhered to said flexible container,
wherein said flexible film member is configured to releasably secure between said opposed ends one of said two lateral end seams of said flexible container subsequent to opening one of said two lateral end seams.

2. The recloseable package of claim 1, wherein said flexible film member has a length that extends from a top lateral edge to a bottom lateral edge of about 1.37 centimeters or greater.

3. The recloseable package of claim 1, wherein said flexible film member has a thickness of from about 8.89 microns to about 76.2 microns.

4. The recloseable package of claim 1, wherein at least a portion of said flexible film member between said opposed ends is temporarily adhered to at least one of said front side or said back side of said flexible container.

5. The recloseable package of claim 1, wherein said flexible container and said flexible film member are configured such that a portion of said flexible container including said one of said two end lateral seams can be releasably secured between said flexible film member and said flexible container subsequent to opening one of said two lateral end seams.

6. The recloseable package of claim 1, wherein at least a portion of said flexible film member between said opposed ends is permanently adhered to at least one of said front side or said back side of said flexible container.

7. The recloseable package of claim 6, wherein said flexible film member has a length that extends from a top lateral edge to a permanently adhered bottom portion of said flexible film member of about 1.78 centimeters or greater.

8. The recloseable package of claim 1, wherein said flexible film member is disposed onto an upper half of said flexible container, the upper half extending from said one of said two lateral end seams.

9. The recloseable package of claim 1, wherein said flexible film member is disposed onto an upper third of said flexible container, the upper third extending from said one of said two lateral end seams.

10. The recloseable package of claim 1, wherein said flexible film member is disposed onto an upper quarter of said flexible container, the upper quarter extending from said one of said two lateral end seams.

11. The recloseable package of claim 1, wherein said flexible film member is disposed between an upper half and an upper third of said flexible container, the upper half and the upper third extending from said one of said two lateral end seams.

12. The recloseable package of claim 1, wherein said flexible film member is disposed at, above or below a fill line for said product.

13. The recloseable package of claim 1, wherein said flexible film member is substantially transparent.

14. The recloseable package of claim 1, wherein said flexible film member further comprises printing thereon.

15. The recloseable package of claim 1, further comprising one or more adhesives disposed onto one or more portions of said flexible film member.

16. A method of fabricating a recloseable package for containing a product therein, said method comprising:
adhering opposed ends of a flexible film member permanently onto a flexible container body film; and
forming the flexible container body film into a flexible container having a front side and a back side sealed together along at least one longitudinal seam and two lateral end seams, the flexible film member structured and arranged on said flexible container so as to releasably secure one of said two lateral end seams of said flexible container subsequent to opening one of said two lateral end seams.

17. A method for releasably securing a recloseable package comprising (i) a flexible container having a front side and a back side sealed together along at least one longitudinal seam and two lateral end seams and (ii) a flexible film member having opposed ends permanently adhered to said flexible container to releasably secure between said opposed ends one of said two lateral end seams of said flexible container, said method comprising:
opening said one lateral end seam; and
securing said one lateral end seam of said flexible container between said flexible container and said flexible film member.

18. A flexible film for forming a recloseable package, said flexible film comprising:
a flexible container body film; and
a flexible film member having opposed ends permanently adhered to said flexible container body film.

19. The flexible film of claim 18, wherein said flexible container body film is selected from the group consisting of one or more paper-based materials, polymeric materials, metallized polymeric materials, metallic foils, and combinations thereof.
